(19) United States
(12) Patent Application Publication
(10) Pub. No.: US 2009/0110412 A1
(43) Pub. Date: Apr. 30, 2009

(54) IMAGE FORMING APPARATUS

(75) Inventor: Akihiko KAKITA, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/237,879

(22) Filed: Sep. 25, 2008

(30) Foreign Application Priority Data
Oct. 24, 2007 (JP) 2007-276227

(51) Int. Cl. G03G 15/00

(52) U.S. Cl. 399/27

(57) ABSTRACT

A color image forming apparatus of an electrophotographic type, includes a toner container containing a toner therein, arranged on an upper portion of an outside of a main frame of the apparatus in which an imagewise exposure section, a developing section and a fixing section are housed.

This application is based on Japanese Patent Application No. 2007-276227 filed on Oct. 24, 2007, which is incorporated hereinto by reference.

### BACKGROUND OF THE INVENTION

The present invention relates to an image forming apparatus of an electrophotographic type, and in particular, to a color image forming apparatus that outputs a large quantity of prints at a high speed.

Color image forming apparatuses of an electrophotographic type, especially, color image forming apparatuses that output a large quantity of prints at a high speed have become to be in heavy usage in the field of shortrun printing.

A location where the most image forming apparatuses are installed is an ordinary office. In these offices, image forming apparatuses are used to output copies wherein the greater part of images is occupied by characters. Further, it is a rare case that the apparatuses are operated continuously for a long time.

However, in the case of an image forming apparatus used in the field of shortrun printing, there are outputted many high multi-level images, namely, images whose toner consumption per one page is high and whose printing rate which means a rate of a toner image on a page to be printed is high, and the apparatus is used in a way to raise its operating rate as far as possible, as in the case of production facilities.

Therefore, an amount of toner consumed per unit time by an image forming apparatus used in the shortrun printing field is incomparably larger than an amount of toner consumed per unit time by an image forming apparatus used in an office.

As a result, a size of a toner container that contains toner to be supplied to an image forming apparatus is extremely large, and in the case of a color image forming apparatus that uses four types of toners for Y (yellow), M (magenta), C (cyan) and K (black), in particular, a decision of places on the apparatus for these toner containers is a serious problem.

Further, since the continuous operations for a long time cause an internal temperature of the image forming apparatus to rise, how to prevent a problem of changes in characteristics caused by temperature rise, such as, for example, a problem of a decline of fluidity of toner is also a serious problem.

Those known as suggestions to prevent temperature rise of a toner bottle representing a toner container include one to provide a partition between a toner bottle and a heat source in the apparatus (for example, see Unexamined Japanese Patent Application Publication No. 2005-31155) and one to arrange a replenishment unit including a toner bottle at a position that is farthest from a fixing section (for example, see Unexamined Japanese Patent Application Publication No. 2005-308962).

In the case of these suggestions, however, it has become difficult to cope with a trend for larger size of a toner container in the high speed color image forming apparatus described above, and to cope with suppression of temperature rise of a toner container and of a toner replenishment section to replenish toner to the portion from the toner container to the developing section.

### SUMMARY OF THE INVENTION

The present invention has been achieved in view of the aforesaid circumstances, and its objective is to realize expansion of a capacity of a toner container in a high speed color image forming apparatus and to prevent temperature rise of toner in a toner container and in a toner replenishment section.

The aforesaid problems are solved by realizing the following aspects. In the color image forming apparatus of an electrophotographic type, a toner container is arranged on the upper portion of the outside of the main frame of the color image forming apparatus in which an imagewise exposure section, a developing section and a fixing section are housed.

### BRIEF DESCRIPTION OF THE DRAWINGS

FIG. 1 is a conceptual diagram of a typical color image forming apparatus.

FIG. 2 is a diagram showing an example of arrangement of a toner bottle representing a toner container.

FIG. 3 is a conceptual diagram of a color image forming apparatus of the invention.

FIG. 4 is a diagram showing an example of arrangement of a toner container.

FIG. 5 is a block diagram showing control relationship of an image forming apparatus.

FIG. 6 is a diagram illustrating a toner replenishment section.

FIG. 7 is a diagram showing an upper part of the main frame.

### DETAILED DESCRIPTION OF THE PREFERRED EMBODIMENT

An embodiment of the invention will be explained as follows, referring to the drawings.

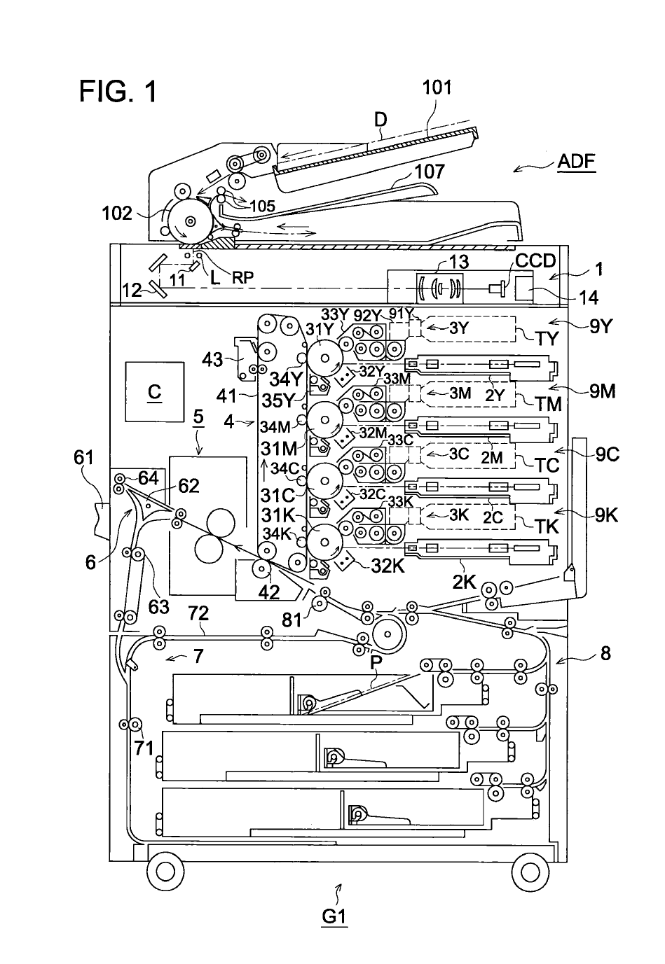

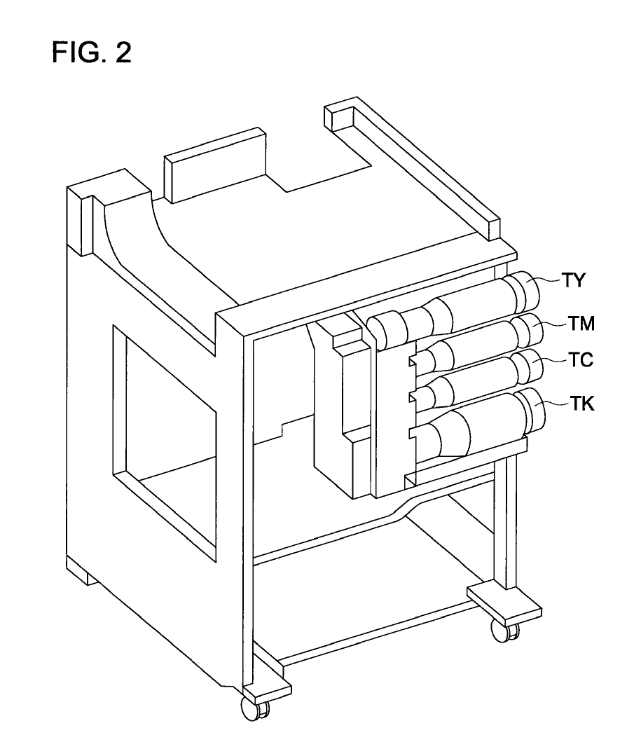

FIG. 1 is a conceptual diagram of typical conventional color image forming apparatus G1 of an electrophotographic type. FIG. 2 is a diagram showing an example of arrangement of a toner bottles TY, TM, TC and TK representing respectively toner containers of toner replenishment sections 9Y, 9M, 9C and 9K of the aforesaid color image forming apparatus G1.

Color image forming apparatus G1 illustrated in the diagram is one called a tandem type color image forming apparatus wherein a plurality of photoreceptors 31Y, 31M, 31C and 31K are arranged longitudinally to face one intermediate transfer belt 41 to form a full-color image.

This color image forming apparatus G1 is equipped, on its upper part, with automatic document feeder ADF.

Documents D placed on document placement table 101 of the automatic document feeder ADF are separated into a sheet to be fed out to a document conveyance path, and is conveyed by document conveyance drum 102.

An image of the document D in transit is read by document reading section 1 at document image reading position RP. The document D terminated in terms of image reading is ejected to document ejection table 107 by first conveyance guide G1 and by document ejection roller 105.

The image forming apparatus G1 is composed of document reading section 1, imagewise exposure sections 2Y, 2M, 2C and 2K, image forming sections 3Y, 3M, 3C and 3K, intermediate transfer section 4, fixing section 5, reversing ejection section 6, re-feeding section 7, feeding section 8 and of controller C, which are housed in one main frame.

In the document reading section 1, an image of a document is illuminated by lamp L at document image reading position RP, and its reflected light is guided by first mirror unit 11, second mirror unit 12 and by lens 13 to form images on a light receiving surface of charge coupled device CCD.

Image signals resulted from photoelectric transduction by charge coupled device CCD are subjected to processes such as A/D conversion, shading correction and compression, by image reading control section 14, to be stored in memory M of controller C as image data.

The aforesaid image data stored in memory M are given appropriate image processing under the conditions established by a user, and output image data are generated.

Each of imagewise exposure sections 2Y, 2M, 2C and 2K is composed of a laser light source, a polygon mirror and a plurality of lenses, and emits a laser beam.

Each of the aforesaid imagewise exposure sections 2Y, 2M, 2C and 2K gives scanning exposure carried out by a laser beam to each surface of photoreceptors 31Y, 31M, 31C and 31K each representing a constituent element for each of image forming sections 3Y, 3M, 3C and 3K, corresponding to output information outputted based on the aforesaid output image data sent from controller C.

The scanning exposure carried out by the laser beam causes a latent image to be formed on each of photoreceptors 31Y, 31M, 31C and 31K.

The image forming section 3Y is composed of photoreceptor 31Y and of those arranged on the periphery of the photoreceptor 31Y including main charging section 32Y, developing section 33Y, first transfer roller 34Y and cleaning section 35Y. The same applies also to photoreceptors 31M, 31C and 31K.

Latent images on respective photoreceptors 31Y, 31M, 31C and 31K are developed by respective developing sections 33Y, 33M, 33C and 33k corresponding to the photoreceptors, and thereby, a toner image is formed on each photoreceptor.

The aforesaid toner images formed respectively on the photoreceptors 31Y, 31M, 31C and 31K are transferred at prescribed positions onto intermediate transfer belt 41 representing an intermediate transfer body in succession by first transfer roller 34Y, 34M, 34C and 34K of intermediate transfer section 4.

Residual toner on the surface of the photoreceptor that has been terminated in terms of transfer of a toner image is removed by each of cleaning sections 35Y, 35M, 35C and 35K.

On the other hand, the aforesaid toner image transferred onto the intermediate transfer belt 41 is transferred by second transfer roller 42 onto sheet P representing a transfer material that is fed from feeding section 8 and is synchronized by sheet feed roller 81 in terms of sheet feed timing.

The surface of the intermediate transfer belt 41 that has been terminated in terms of transfer of the toner image onto sheet P is cleaned by belt cleaning section 43, to be ready for succeeding image transfer.

On the other hand, sheet P carrying a toner image is sent to fixing section 5 where the sheet P is pressed and heated, thus, the toner image is fixed on the sheet P.

Sheet P terminated in terms of fixing processing by fixing section 5 is conveyed by reverse ejection section 6 to be ejected to sheet ejection table 61. When ejecting sheet P after it is reversed inside out, the sheet P is guided downward once by sheet ejection guide 62, then, a trailing edge of the sheet P is interposed by sheet ejection reversing roller 63 so that the sheet P is reversed, and it is guided by the sheet ejection guide 62 to sheet ejection roller 64 to be ejected.

In the meantime, when forming images also on the reverse side of sheet P, the sheet P terminated in terms of image fixing on the adverse side is conveyed to re-feeding section 7 located at a lower part by the sheet ejection guide 62, then, a trailing edge of the sheet P is interposed by re-feed reversing roller 71 to be conveyed reversely, thus, the sheet P is reversed and is sent out to re-feed conveyance path 72 to be ready for image forming on the reverse side.

On the color image forming apparatus G1 described above, there are provided toner replenishment sections 9Y, 9M, 9C and 9K which respectively feed toner to developing sections 33Y, 33M, 33C and 33K of image forming sections for respective colors.

The toner replenishment section 9Y is composed of toner bottle TY, bottle holding section 91Y and hopper 92Y. Meanwhile, each of the toner replenishment sections 9M, 9C and 9K is also composed in the same way.

The toner bottle TY is a toner container that is held by the bottle holding section 91Y in a rotatable manner.

The bottle holding section 91Y causes toner bottle TY to rotate based on replenishment signals sent from a sensor that is installed on hopper 92Y that stores temporarily toner ejected from toner bottle TY.

When the toner bottle TY rotates, toner is ejected to hopper 92Y from an outlet of the toner bottle.

The toner ejected to the hopper 92Y is sent to developing section 33Y based on toner replenishment signals generated on the basis of detection signals of a toner concentration sensor in the developing section 33Y.

Incidentally, the toner replenishment section described above is of the well-known structure.

There has been an explanation of conventional color image forming apparatus G1, and in the foregoing, there is a limitation for expansion of a size of a toner container that is housed in a main frame together with an imagewise exposure section, an image forming section, a sheet feed section, a transfer section and a fixing section, and it is still difficult to prevent a temperature rise of toner in the toner container even when the toner container is arranged to be farthest from a heat source such as a fixing section as far as possible in the main frame.

To solve these problems relating to heat inside the apparatus, the invention is one wherein toner containers are arranged outside the main frame that houses therein members generating heat such as an imagewise exposure section, a developing section and a fixing section.

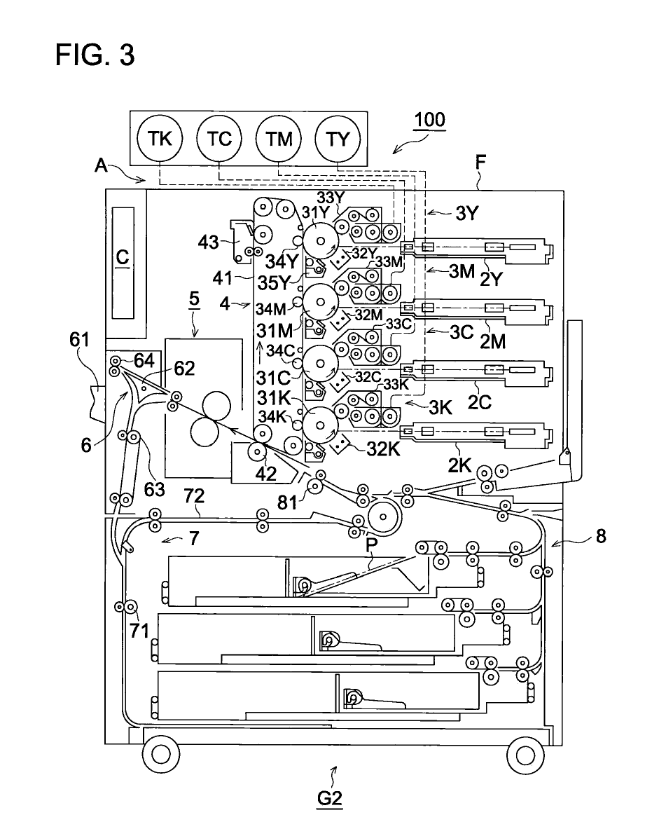

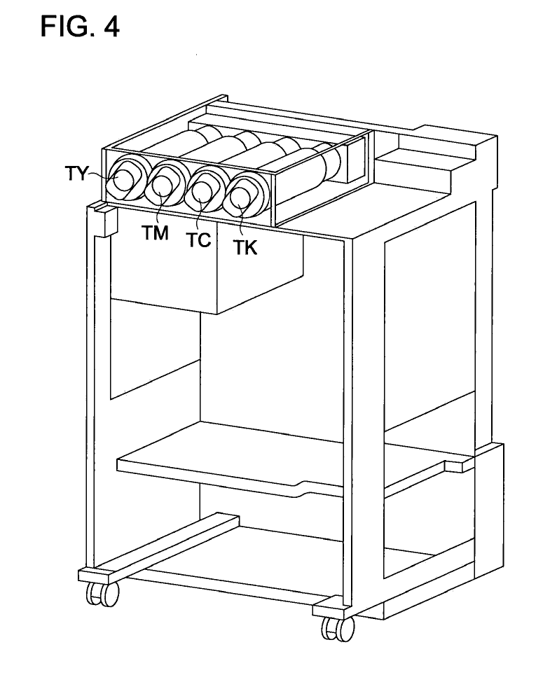

FIG. 3 is a conceptual diagram of color image forming apparatus G2 of the invention. FIG. 4 is a diagram showing an example of arrangement of toner containers.

The color image forming apparatus G2 is one to output full-color prints at high speed, and image information to be outputted is sent from information processing equipment PC that is connected with communication section TR.

Therefore, automatic document feeder ADF and document reading section 1 which are equipped on existing color image forming apparatus G1 which have been explained are not equipped on the color image forming apparatus G2.

As stated earlier, a distinctive feature of the color image forming apparatus G2 of the invention is that toner containers are arranged at a location that is outside and above main frame F that houses therein an imagewise exposure section, a developing section and a fixing section.

As illustrated, toner replenishment sections 100 which replenish toner from respective toner bottles TY, TM, TC and TK each representing a toner container to respective developing sections 33Y, 33M, 33C and 33K is arranged at a location that is outside and above main frame F that houses therein an imagewise exposure section, a developing section and a fixing section which generate heat.

In the meantime, a space that suppresses heat conduction from a heat generating source is provided between the aforesaid main frame F shown with arrow A and the toner replenishment section 100 in FIG. 3.

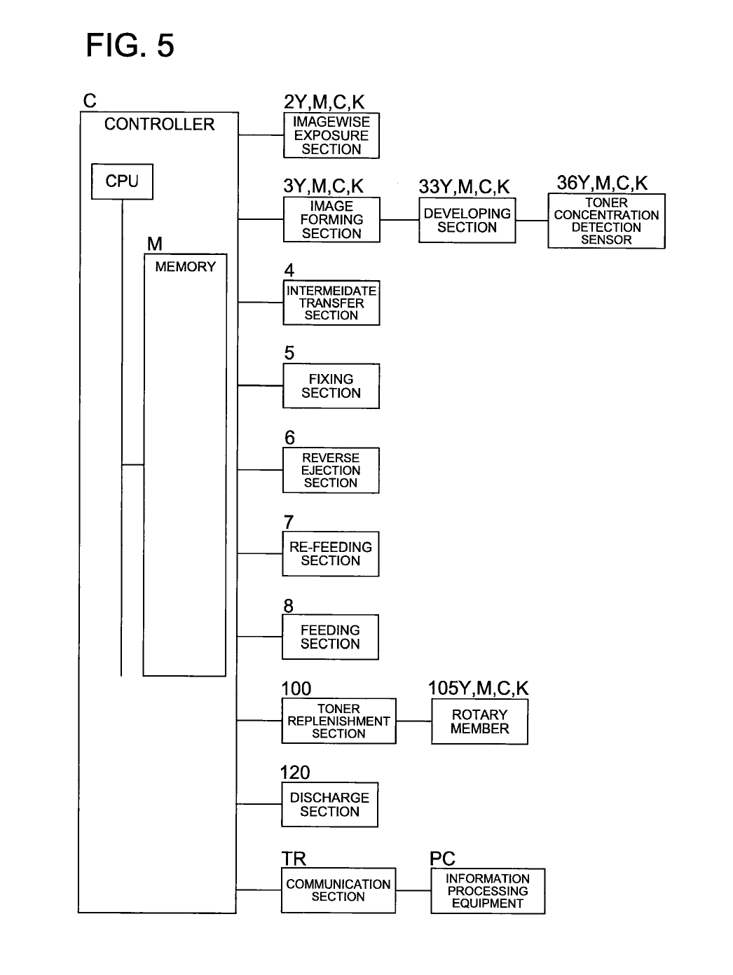

FIG. 5 is a block diagram showing controls in connection with image forming apparatus G2.

Controller C of the image forming apparatus G2 is a computer system having circuits for driving to control respective parts including CPU, memory M, I/O port and interface for communication, and each control is conducted by carrying out programs stored in memory M.

In the present diagram, blocks which are not related directly to the explanation of the invention are omitted in terms of description.

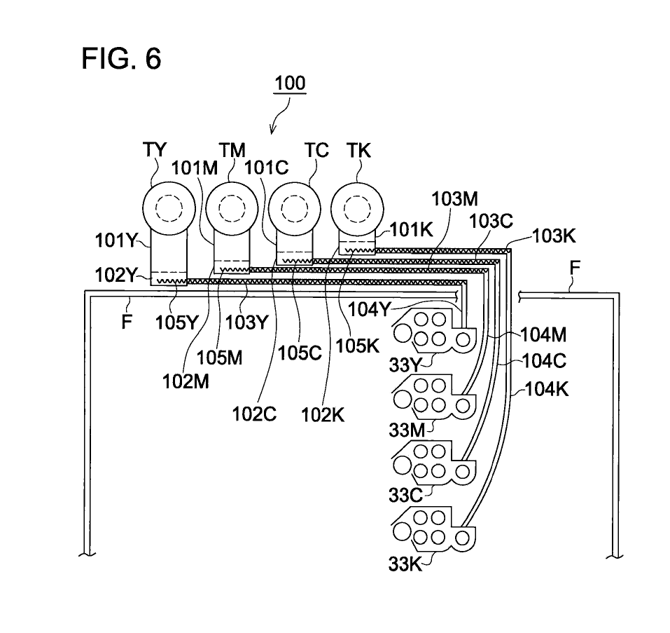

FIG. 6 is a diagram for illustrating toner replenishment section 100. Meanwhile, each of toner bottles TY, TM, TC and TK representing toner containers is arranged so that its bottom portion may be on this side and its outlet for toner may be on the back side, in the direction perpendicular to the page.

The toner replenishment section 100 is a mechanism to eject toner from each of toner bottles TY, TM, TC and TK, and to send the ejected toner to each of developing sections 33Y, 33M, 33C and 33K.

Each of toner container holding sections 101Y, 101M, 101C and 101K holds each of toner bottles TY, TM, TC and TK while it is rotating, and toner in each of toner bottles TY, TM, TC and TK is ejected by the bottle rotation into each of toner hoppers 102Y, 102M, 102C and 102K through an outlet of the bottle.

In each of the toner hoppers 102Y, 102M, 102C and 102K, there is provided a sensor (not shown) that detects an amount of toner in the hopper, and controller C controls rotation actions of toner container holding sections 101Y, 101M, 101C and 101K based on signals of the sensor, thus, a certain amount of toner can be kept in the hopper constantly.

Each of horizontal conveyance sections 103Y, 103M, 103C and 103K is equipped therein with each of rotary members 105Y, 105M, 105C and 105K having respectively a spiral-shaped wing, and when each of the rotary members 105Y, 105M, 105C and 105K is rotated, toner in each of hoppers 102Y, 102M, 102C and 102K is conveyed out.

Toner conveyed to an end portion of each of the aforesaid horizontal toner conveyance sections 103Y, 103M, 103C and 103K is put in each of developing sections 33Y, 33M, 33C and 33K through each of guide members 104Y, 104M, 104C and 104K.

In the meantime, controller C judges whether toner replenishment to each of developing sections 33Y, 33M, 33C and 33K is needed or not, based on signals coming from toner concentration detection sensors 36Y, 36M, 36C and 36K equipped respectively on developing sections 33Y, 33M, 33C and 33K, and conducts rotation control for the aforesaid rotary members 105Y, 105M, 105C and 105K.

When rotations of the rotary members 105Y, 105M, 105C and 105K are stopped, toner in each of the horizontal conveyance sections 103Y, 103M, 103C and 103K stays therein as it is.

When a temperature of toner staying in the toner replenishment section 100 rises, as in the foregoing, melted toner particles stick to each other to become flocculates which are conveyed to the developing section to cause image defects.

In the image forming apparatus G2 of the present embodiment, a portion where toner particles of toner bottles Ty, TM, TC and TK and of toner replenishment section 100 stagnate is arranged outside the main frame, and a space is provided between the portion and the main frame so that an influence of heat coming from developing sections 33Y, 33M, 33C and 33K may be reduced.

Meanwhile, for toner replenishment to developing sections 33Y, 33M, 33C and 33K, it is also possible to employ the structure wherein a toner hopper is provided just prior to each developing section, and toner is sent to the toner hopper so that a certain amount of toner may be kept therein, and toner replenishment is conducted based on signals coming from toner concentration detection sensors 36Y, 36M, 36C and 36K provided respectively on the developing sections 33Y, 33M, 33C and 33K.

By arranging toner containers and a toner replenishment section at a location that is outside and above the main frame that houses therein imagewise exposure sections, developing sections and fixing sections, as explained above, it is possible to enlarge a capacity of toner containers greatly.

Since toner particles stagnating in toner bottles TY, TM, TC and TK representing toner containers or in toner replenishment section 100 are placed at a location that is away from members generating heat such as fixing sections, imagewise exposure sections and developing sections, it is possible to suppress temperature rise of toner.

Incidentally, though it is desirable that a space provided between a toner container and the main frame, or between a toner replenishment section and the main frame is large for suppressing temperature rise of toner in a toner container or in a toner replenishment section, a size of the space is determined by considering other restriction conditions on the design aspect, for example, a size of the apparatus.

Further, with respect to a position of the toner container in the horizontal direction, it is preferable that the toner container is arranged so that conveyance distances for horizontal conveyance sections 103Y, 103M, 103C and 103K of toner replenishment section 100 may be shortest as far as possible.

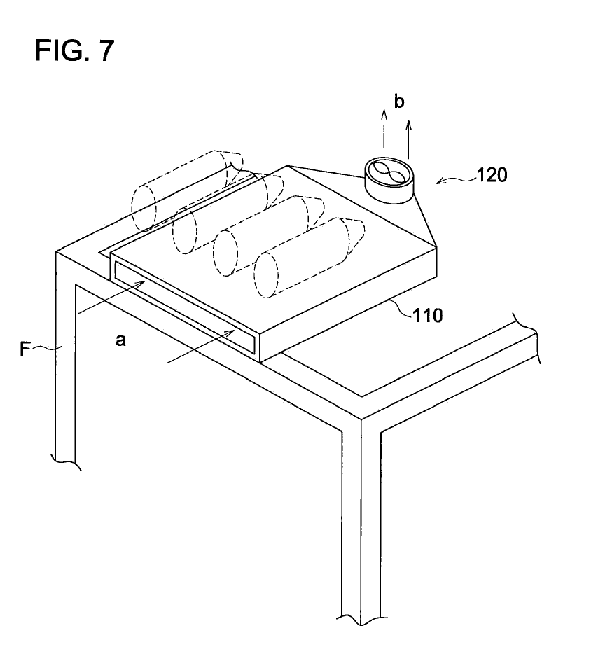

FIG. 7 is a diagram showing an upper part of main frame F.

Main frame F housing therein imagewise exposure sections 2Y, 2M, 2C and 2K, developing sections 33Y, 33M, 33C and 33K and fixing section 5 shown in FIG. 3 is made of plural angle members and sheet materials which are put together, and a hollow member is provided above the main frame.

In the meantime, although hollow member 110 is provided above the main frame in the present embodiment, it is also possible to make a part of the upper member of the main frame to be a hollow member.

By providing hollow member 110 between a heat generating source and a toner container or between a heat generating source and a toner replenishment section, and by making a flow of air in the hollow member, it is possible to suppress more surely temperature rise of toner in the toner container or in the toner replenishment section.

In the present embodiment, discharge section 120 is provided on the end portion of the aforesaid hollow member 110 to suck in air as shown with arrow “a” and to discharge to the outside of the apparatus as shown with arrow “b”.

In the meantime, a size, a shape and a quantity of hollow members 110 and an arrangement of the discharge section 120 are those determined properly in the design step.

By providing hollow member 110 that serves as a cooling device by means of air stated above, temperature rise in the toner container or in the toner replenishment section can be suppressed more effectively.

The present invention makes it possible to enlarge greatly a capacity of a toner container in a high speed color image forming apparatus, and to prevent temperature rise of toner in a toner container.

What is claimed is:

1. A color image forming apparatus of an electrophotographic type, comprising:
a toner container containing a toner therein, arranged on an upper portion of an outside of a main frame of the apparatus in which an imagewise exposure section, a developing section and a fixing section are housed.

2. The color image forming apparatus of claim 1, further comprising a toner replenishment section, which replenishes the toner discharged from the toner container onto the developing section, provided on the upper portion of the outside of the main frame.

3. The color image forming apparatus of claim 2, wherein a space is provided between the main frame and one of the toner container and the toner replenishment section.

4. The color image forming apparatus of claim 2, wherein a hollow member is provided between the main frame and one of the toner container and the toner replenishment section.

5. The color image forming apparatus of claim 1, further comprising a member constituting the upper portion, which is formed by a hollow member.

6. The color image forming apparatus of claim 4, further comprising a discharge section which discharges air inside the hollow member to the outside of the apparatus.
